(19) United States
(12) Patent Application Publication
(10) Pub. No.: US 2026/0319533 A1
(43) Pub. Date: Oct. 15, 2026

(54) HYBRID LOW DROP-OUT REGULATOR AND SEMICONDUCTOR DEVICE INCLUDING THE SAME

(71) Applicant: SK hynix Inc., Icheon-si (KR)

(72) Inventors: Seong Jin YUN, Icheon-si (KR); Young Sub YUK, Icheon-si (KR)

(21) Appl. No.: 19/306,407

(22) Filed: Aug. 21, 2025

(30) Foreign Application Priority Data
Apr. 10, 2025 (KR) 10-2025-0046579

(51) Int. Cl. G05F 1/563

(52) U.S. Cl. CPC G05F 1/563

(57) ABSTRACT

A low drop-out (LDO) regulator includes: a comparator configured to generate a first comparison signal and a second comparison signal, having an analog level difference based on a level difference between a preset first voltage and a second voltage from an output node, a coarse adjustment component configured to determine frequencies of a first and second control signal based on levels of the first and second comparison signals, respectively, and to digitally adjust a coarse current to a control node based on a frequency difference, a fine adjustment component configured to analogically adjust a fine current to the control node based on the level difference between the comparison signals, and an output component configured to adjust an output current from an input node to the output node according to a control voltage at the control node, thereby adjusting an output voltage at the output node.

### CROSS-REFERENCE TO RELATED APPLICATION

This application claims priority under 35 U.S.C. § 119(a) to Korean Patent Application No. 10-2025-0046579, filed in the Korean Intellectual Property Office on Apr. 10, 2025 the entire contents of which are incorporated herein by reference.

### BACKGROUND

### 1. Field

Various embodiments relate to a semiconductor design technology, and specifically, to a low drop-out (LDO) regulator that operates in a hybrid manner combining digital and analog operations, and a semiconductor device including the low drop-out (LDO) regulator.

### 2. Discussion of the Related Art

Recently, with trending diversification and miniaturization of devices, efforts to integrate various circuits into a single chip as a system-on-chip (SoC) have increased. For example, various types of circuits such as analog, digital, and radio frequency (RF) circuits are integrated into a single chip. When various types of circuits are integrated into a single chip, there is a need for an efficient and stable power supply voltage management system.

A low drop-out (LDO) regulator is one of the essential components in a power supply voltage management system and is used to supply a stable power supply voltage to such circuits. To this end, an LDO regulator is used together with a switching regulator. Because the LDO regulator has a simple configuration with a small number of external circuits and does not generate internal ripple voltage, the LDO regulator is mainly used to supply voltage to circuits such as an analog-to-digital converter (ADC) or a voltage-controlled oscillator (VCO), which are sensitive to supply voltage.

In an analog LDO regulator, the power supply voltage cannot be lowered due to the use of an amplifier, and a relatively wide bandwidth is required for high-speed operation. In contrast, because a digital LDO regulator does not use an amplifier, the level of the power supply voltage can be significantly reduced. Furthermore, the digital LDO regulator has a bandwidth that is nearly infinite, thus providing an advantage in facilitating high-speed operation.

However, the digital LDO regulator is required to operate at a higher frequency in order to achieve faster transient response characteristics, and as operating speed increases, current consumption significantly increases. In addition, a digital LDO regulator has disadvantages including vulnerability to supply noise and difficulty in achieving accurate voltage regulation.

### SUMMARY

Various embodiments are directed to providing a low drop-out (LDO) regulator capable of operating in a hybrid manner that automatically switches between digital and analog uses based on a level of a regulating voltage, and a semiconductor device including the LDO regulator.

Technical problems to be solved by the present disclosure are not limited to the aforementioned technical problems and the other technical problems not mentioned here will be clearly understood by those skilled in the art from the following description.

An aspect of an embodiment in the invention, a low drop-out (LDO) regulator may include: a comparator configured to generate a first comparison signal and a second comparison signal between which a level difference is determined in an analog manner, based on a level difference between a first voltage having a preset level and a second voltage provided from an output node; a coarse adjustment component configured to determine a frequency of a first control signal and a frequency of a second control signal based on a level of the first comparison signal and a level of the second comparison signal, respectively, and to adjust a magnitude of a coarse current that is transmitted to a control node, in a digital manner based on a frequency difference between the first control signal and the second control signal; a fine adjustment component configured to adjust a magnitude of a fine current that is transmitted to the control node, in an analog manner based on the level difference between the first comparison signal and the second comparison signal; and an output component configured to adjust a magnitude of the output current that is transmitted from an input node to an output node, according to a level of a control voltage present at the control node, and to adjust a level of an output voltage present at the output node.

An aspect of an embodiment in the invention, a semiconductor device may include: a low drop-out (LDO) regulator configured to: generate a first comparison signal and a second comparison signal between which a level difference is determined in an analog manner based on a level difference between a first voltage having a preset level and a second voltage provided from an output node; convert the level difference between the first comparison signal and the second comparison signal to a frequency difference and adjust, in a digital manner, a magnitude of a coarse current that is transmitted to a control node; adjust a magnitude of a fine current that is transmitted to the control node, in an analog manner according to the level difference between the first comparison signal and the second comparison signal; and adjust a magnitude of an output current that is transmitted from an input node to the output node, based on the magnitude of the coarse current and the magnitude of the fine current; and a load circuit configured to receive at least a portion of the output current transmitted through the output node, as a load current, and to perform a preset operation.

### BRIEF DESCRIPTION OF THE DRAWINGS

FIG. 1 is a diagram illustrating a semiconductor device including a hybrid low drop-out (LDO) regulator according to an embodiment of the disclosure.

FIG. 2 is a diagram illustrating in detail a configuration of a coarse adjustment component among components of a hybrid LDO regulator according to an embodiment of the disclosure.

FIGS. 3A to 3C are diagrams illustrating a detailed circuit configuration and operation of a hybrid LDO regulator according to an embodiment of the disclosure.

FIG. 4 is a diagram illustrating a detailed circuit configuration of a digital driver included in the coarse adjustment component among the components of a hybrid LDO regulator according to an embodiment of the disclosure.

FIG. 5 is a diagram illustrating an operation of a coarse adjustment component according to a difference in level between a first voltage and a second voltage in a hybrid LDO regulator according to an embodiment of the disclosure.

FIGS. 6A and 6B are diagrams illustrating operations of a frequency-to-digital converting component in a hybrid LDO regulator according to an embodiment of the disclosure.

FIGS. 7A and 7B are diagrams illustrating an operation of a hybrid LDO regulator according to an embodiment of the disclosure.

### DETAILED DESCRIPTION

Various embodiments of the present disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). Examples of block/unit/circuit/component used with the “configured to” language includes hardware-for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in the disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

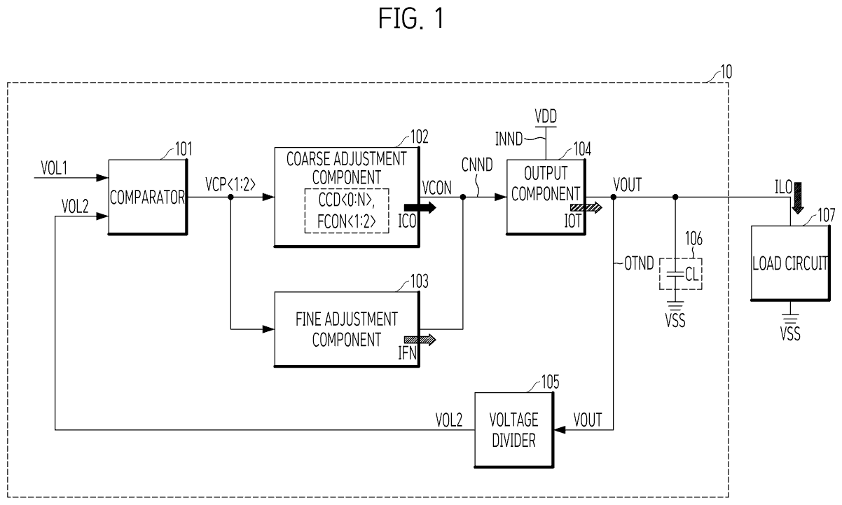

FIG. 1 is a diagram illustrating a semiconductor device including a hybrid low drop-out (LDO) regulator according to an embodiment of the disclosure.

Referring to FIG. 1, the semiconductor device according to an embodiment of the disclosure may include a hybrid LDO regulator 10, and a load circuit 107.

The hybrid LDO regulator 10 may generate a first comparison signal VCP1 and a second comparison signal VCP2, between which a level difference is determined in an analog manner according to a level difference between a first voltage VOL1 having a preset level and a second voltage VOL2 provided from an output node OTND. Furthermore, the hybrid LDO regulator 10 may adjust a magnitude of a coarse current ICO, which is transmitted to a control node CNND, in a digital manner by converting a level difference between the first comparison signal VCP1 and the second comparison signal VCP2 into a frequency difference. In addition, the hybrid LDO regulator 10 may adjust a magnitude of a fine current IFN, which is transmitted to a control node CNND, in an analog manner based on the level difference between the first comparison signal VCP1 and the second comparison signal VCP2. Furthermore, the hybrid LDO regulator 10 may adjust a magnitude of an output current IOT transmitted from an input node INND to the output node OTND based on the magnitudes of the coarse current ICO and the fine current IFN transmitted to the control node CNND.

The load circuit 107 may receive at least a portion of the output current IOT transmitted through the output node OTND as a load current ILO and perform a preset operation. In other words, the output current IOT generated by the hybrid LDO regulator 10 is transmitted to the load circuit 107 through an output node OTND, and the load circuit 107 may perform the preset operation using the load current ILO, which corresponds to at least a portion of the received output current IOT. The magnitude of the load current ILO may vary depending on a type of the preset operation performed in the load circuit 107.

As described above, in the hybrid LDO regulator 10, the output current IOT is supplied to the output node OTND, and in the load circuit 107, the load current ILO is received from the output node OTND. Accordingly, a level of an output voltage VOUT present at the output node OTND may be determined depending on adjustment of the magnitudes of the output current IOT and the load current ILO.

For example, when the magnitude of the output current IOT and the magnitude of the load current ILO remain the same over time, the level of the output voltage VOUT may remain unchanged over time. In another example, when the magnitude of the output current IOT becomes smaller than the magnitude of the load current ILO over time, the level of the output voltage VOUT may decrease over time. In a further example, when the magnitude of the output current IOT becomes greater than the magnitude of the load current ILO over time, the level of the output voltage VOUT may increase over time.

Preferably, the hybrid LDO regulator 10 maintains the level of the output voltage VOUT at a target level. To this end, the hybrid LDO regulator 10 may perform an operation of maintaining the output voltage VOUT at the target level by adjusting the magnitude of the output current IOT in response to detection of a variation in the magnitude of the load current ILO.

Specifically, the hybrid LDO regulator 10 may include a comparator 101, a coarse adjustment component 102, a fine adjustment component 103, and an output component 104. In addition, the hybrid LDO regulator 10 may further include a voltage divider 105 and a load capacitor 106.

The comparator 101 may generate the first comparison signal VCP1 and the second comparison signal VCP2. The difference between the levels of these signals is determined in an analog manner according to the difference in levels between the first voltage VOL1 having a preset level and the second voltage VOL2 provided from the output node OTND. The comparator 101 may determine, in an analog manner, the difference between the first comparison signal VCP1 and the second comparison signal VCP2, based on the amount by which the level of the second voltage VOL2 (which is controlled based on the level of the output voltage VOUT present at the output node OTND) is higher or lower than the level of the first voltage VOL1, which is fixed at a preset level.

In an embodiment, the comparator 101 determines, in an analog manner, a difference in levels between the first comparison signal VCP1 and the second comparison signal VCP2 in proportion to a difference in levels between the first voltage VOL1 and the second voltage VOL2.

In an embodiment, when the level of the first voltage VOL1 is higher than the level of the second voltage VOL2, the comparator 101 sets the level of the first comparison signal VCP1 and the level of the second comparison signal VCP2 such that the level of the first comparison signal VCP1 is higher than the level of the second comparison signal VCP2, with reference to a half level between a level of a power supply voltage VDD and a level of a ground voltage VSS.

In an embodiment, when the level of the first voltage VOL1 is lower than the level of the second voltage VOL2, the comparator 101 sets the level of the first comparison signal VCP1 and the level of the second comparison signal VCP2 such that the level of the first comparison signal VCP1 is lower than the level of the second comparison signal VCP2, with reference to a half level between the level of the power supply voltage VDD and the level of the ground voltage VSS.

In addition, the comparator 101 may amplify the difference in levels between the first voltage VOL1 and the second voltage VOL2 using a preset ratio, and determine, in an analog manner, a difference in levels between the first comparison signal VCP1 and the second comparison signal VCP2.

In an embodiment, the comparator 101 amplifies a difference between the first voltage VOL1 and the second voltage VOL2 by a factor of 1000 and determines a difference between the first comparison signal VCP1 and the second comparison signal VCP2. For example, when a level difference between the first voltage VOL1 and the second voltage VOL2 is 1 mV, the comparator 101 amplifies 1 mV by a factor of 1000 and determines that a level difference between the first comparison signal VCP1 and the second comparison signal VCP2 is 1 V.

The voltage divider 105 may generate the second voltage VOL2 by dividing the level of the output voltage VOUT at a preset ratio. For example, the voltage divider 105 generates the second voltage VOL2 by dividing the level of the output voltage VOUT at a ratio of 2:3.

The voltage divider 105 is a component that may be optionally included in the hybrid LDO regulator 10. The voltage divider 105 may be omitted depending on the choice of the designer.

In an embodiment, when the voltage divider 105 is included in the hybrid LDO regulator 10 as shown in FIG. 1, after the second voltage VOL2 is determined at a level corresponding to ⅔ of the level of the output voltage VOUT is input to the comparator 101, and the first voltage VOL1 is set to a level corresponding to ⅔ of the target level of the output voltage VOUT.

In an embodiment, unlike the configuration shown in the drawing, when the voltage divider 105 is not included in the hybrid LDO regulator 10, and when the output voltage VOUT is directly used as the second voltage VOL2, the first voltage VOL1 is set to the target level of the output voltage VOUT.

The coarse adjustment component 102 may determine a frequency of a first control signal FCON1 based on the level of the first comparison signal VCP1, and may determine a frequency of a second control signal FCON2 based on the level of the second comparison signal VCP2. Furthermore, the coarse adjustment component 102 may adjust the magnitude of the coarse current ICO transmitted to the control node CNND, in a digital manner based on a frequency difference between the first control signal FCON1 and the second control signal FCON2.

In an embodiment, the coarse adjustment component 102 determines the frequency of the first control signal FCON1 in proportion to the level of the first comparison signal VCP1, and determines the frequency of the second control signal FCON2 in proportion to the level of the second comparison signal VCP2. In other words, the coarse adjustment component 102 may generate the first control signal FCON1, the frequency of which increases in response to an increase in the level of the first comparison signal VCP1, and may generate the second control signal FCON2, the frequency of which increases in response to an increase in the level of the second comparison signal VCP2. The range of variation in frequency of the first control signal FCON1 may be the same as the range of variation in frequency of the second control signal FCON2. For example, when the levels of the first comparison signal VCP1 and the second comparison signal VCP2 are the same, the frequencies of the first control signal FCON1 and the second control signal FCON2 are the same.

The coarse adjustment component 102 may change a digital value of a control code CCD<0:N> based on a frequency difference between the first control signal FCON1 and the second control signal FCON2. The coarse adjustment component 102 may adjust the magnitude of the coarse current ICO transmitted to the control node CNND, in a digital manner according to the digital value of the control code CCD<0:N>. The coarse adjustment component 102 may determine the magnitude of the coarse current ICO by adjusting a magnitude of a current supplied from a power supply voltage (VDD) terminal to the control node CNND and a magnitude of a current sunk from the control node CNND to a ground voltage (VSS) terminal, according to the value of the control code CCD<0:N>.

In an embodiment, when the frequency of the first control signal FCON1 is greater than the frequency of the second control signal FCON2, the coarse adjustment component 102 generates a control code CCD<0:N> having a value that increases the magnitude of the coarse current ICO transmitted to the control node CNND.

In an embodiment, when the frequency of the first control signal FCON1 is less than the frequency of the second control signal FCON2, the coarse adjustment component 102 generates a control code CCD<0:N> having a value that decreases the magnitude of the coarse current ICO transmitted to the control node CNND.

In an embodiment, the coarse adjustment component 102 generate a control code CCD<0:N> having a disable value (i.e., a minimum value) and does not change (i.e., neither increases nor decreases) the magnitude of the coarse current ICO transmitted to the control node CNND.

The fine adjustment component 103 may adjust the magnitude of the fine current IFN transmitted to the control node CNND, in an analog manner based on a level difference between the first comparison signal VCP1 and the second comparison signal VCP2.

In an embodiment, when the level of the second comparison signal VCP2 is higher than that of the first comparison signal VCP1, the fine adjustment component 103 increases the magnitude of the fine current IFN by adjusting, in an analog manner, the magnitude of a current sourced from the power supply voltage (VDD) terminal to the control node CNND.

In an embodiment, when the level of the second comparison signal VCP2 is lower than that of the first comparison signal VCP1, the fine adjustment component 103 decreases the magnitude of the fine current IFN by adjusting, in an analog manner, a magnitude of a current sunk from the control node CNND to the ground voltage (VSS) terminal.

The output component 104 may adjust the magnitude of the output current IOT transmitted from the input node INND to the output node OTND, according to a level of the control voltage VCON present at the control node CNND, and may thereby adjust the level of the output voltage VOUT present at the output node OTND. In other words, the output component 104 may adjust the magnitude of the output current IOT that is transmitted from the input node INND, which is connected to the power supply voltage (VDD) terminal, to the output node OTND in response to the control voltage VCON, the level of which is determined based on a combined current of the coarse current ICO transmitted to the control node CNND through the coarse adjustment component 102 and the fine current IFN transmitted to the control node CNND through the fine adjustment component 103.

The load capacitor 106 may be a component connected to the output node OTND to reduce the influence of a parasitic element present at the output node OTND. In other words, the load capacitor 106 connected to the output node OTND may prevent the level of the output voltage VOUT present at the output node OTND from rapidly changing when the load current ILO that is supplied to the load circuit 107 changes rapidly, thereby enabling faster recovery of the hybrid LDO regulator 10.

The coarse adjustment component 102 may be set to have a current driving capability that is M times greater than that of the fine adjustment component 103. In other words, when the levels of the first comparison signal VCP1 and the second comparison signal VCP2 are the same, the magnitude of the coarse current ICO transmitted from the coarse adjustment component 102 to the control node CNND may be M times greater than the magnitude of the fine current IFN transmitted from the fine adjustment component 103 to the control node CNND. For example, M is a natural number equal to or greater than 2.

The reason why the coarse adjustment component 102 is set to have a current driving capability that is M times greater than that of the fine adjustment component 103 is that the coarse adjustment component 102 and the fine adjustment component 103 operate in different manners as described in the following.

As described above, the coarse adjustment component 102 performs an operation of converting a digital value of a control code CCD<0:N> based on a frequency difference between the first control signal FCON1 and the second control sigIInal FCON2. Therefore, when the frequency difference between the first control signal FCON1 and the second control signal FCON2 is less than or equal to a threshold value, that is, when the difference between the first comparison signal VCP1 and the second comparison signal VCP2 is less than or equal to the threshold value, the digital value of the control code CCD<0:N> does not be changed.

In other words, when the level difference between the first comparison signal VCP1 and the second comparison signal VCP2 is less than or equal to the threshold value, the coarse adjustment component 102 may not apply a change in the digital value of the control code CCD<0:N>, and accordingly, may not adjust the magnitude of the coarse current ICO that is transmitted to the control node CNND. That is, when the level difference between the first comparison signal VCP1 and the second comparison signal VCP2 is less than or equal to the threshold value, the coarse adjustment component 102 may not transmit the coarse current ICO to the control node CNND.

Accordingly, the coarse adjustment component 102 may adjust the magnitude of the coarse current ICO that is transmitted to the control node CNND only when the level difference between the first comparison signal VCP1 and the second comparison signal VCP2 exceeds the threshold value, resulting in a change in the digital value of the control code CCD<0:N>.

In summary, in an initial period of a regulating operation in which a difference in levels between the first comparison signal VCP1 and the second comparison signal VCP2 exceeds a threshold value, the coarse adjustment component 102 may transmit the coarse current ICO to the control node CNND with a relatively high current driving capability compared to that of the fine adjustment component 103, thereby rapidly reducing the level difference between the first comparison signal VCP1 and the second comparison signal VCP2. Subsequently, in a later period of the regulating operation in which the level difference between the first comparison signal VCP1 and the second comparison signal VCP2 is less than or equal to the threshold value, the coarse adjustment component 102 may not operate, and therefore, may not consume current.

In addition, because the fine adjustment component 103 adjusts the magnitude of the fine current IFN in an analog manner based on a level difference between the first comparison signal VCP1 and the second comparison signal VCP2, the level difference between the first comparison signal VCP1 and the second comparison signal VCP2 may be applied to adjusting the magnitude of the fine current IFN even when the level difference is less than or equal to the threshold value.

Also, the fine adjustment component 103 may apply the level difference between the first comparison signal VCP1 and the second comparison signal VCP2 to adjusting the magnitude of the fine current IFN even when the level difference exceeds the threshold value. However, because the current driving capability of the fine adjustment component 103 is significantly smaller than that of the coarse adjustment component 102 (e.g., 1/10 of the magnitude), the fine adjustment component 103 functions only to assist the operation of the coarse adjustment component 102.

In summary, in the later period of the regulating operation in which the level difference between the first comparison signal VCP1 and the second comparison signal VCP2 is less than or equal to the threshold value, the fine adjustment component 103 may transmit the fine current IFN to the control node CNND with a relatively small current driving capability. Therefore, only a relatively small amount of current is consumed compared to the current consumption of the coarse adjustment component 102 (which operates in the initial period) because the coarse adjustment component 102 does not operate in the later period. Furthermore, an increase in the level difference between the first comparison signal VCP1 and the second comparison signal VCP2 may be prevented.

For reference, in the above description, the variable N used in the control code CCD<0:N> may be a natural number equal to or greater than 1.

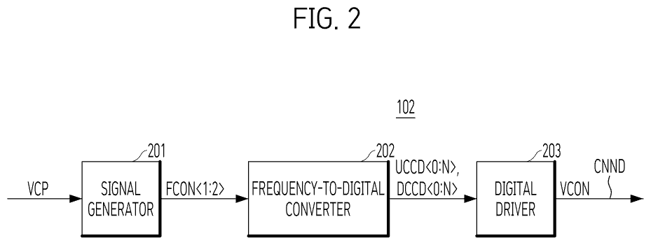

FIG. 2 is a diagram illustrating in detail a configuration of a coarse adjustment component among components of a hybrid LDO regulator according to an embodiment of the disclosure.

Referring to FIG. 2, a coarse adjustment component 102 among the components of a hybrid LDO regulator 10 may include a signal generator 201, a frequency-to-digital converter 202, and a digital driver 203.

The signal generator 201 may determine the frequency of the first control signal FCON1 in an analog manner based on the level of the first comparison signal VCP1. In addition, the signal generator 201 may determine the frequency of the second control signal FCON2 in an analog manner based on the level of the second comparison signal VCP2.

In addition, the signal generator 201 may generate the first control signal FCON1, the frequency of which increases in response to an increase in the level of the first comparison signal VCP1. Furthermore, the signal generator 201 may generate the second control signal FCON2, the frequency of which increases in response to an increase in the level of the second comparison signal VCP2. The signal generator 201 may control the range of variation in frequency variation of the first control signal FCON1 corresponding to the level of the first comparison signal VCP1 to be the same as the range of variation in frequency of the second control signal FCON2 corresponding to the level of the second comparison signal VCP2. For example, the signal generator 201 may generate the first control signal FCON1 and the second control signal FCON2 so that the signals have the same frequency when the first comparison signal VCP1 and the second comparison signal VCP2 have the same level.

For example, the comparator 101 outputs a first comparison signal VCP1 having the level of the power supply voltage VDD and a second comparison signal VCP2 having the level of the ground voltage VSS. In this case, the signal generator 201 may generate the first control signal FCON1 having a preset maximum frequency in response to the first comparison signal VCP1 having a voltage level at the power supply voltage VDD level. In addition, the signal generator 201 may generate the second control signal FCON2 having a preset minimum frequency in response to the second comparison signal VCP2 having a voltage level at the ground voltage VSS level.

For instance, assuming that the power supply voltage VDD has a level of 1 V and the ground voltage VSS has a level of 0 V, the comparator 101 generates the first comparison signal VCP1 having a level of 750 mV, which is higher by 250 mV than 0.5 V, which is ½ of a difference between the level of the power supply voltage VDD and the level of the ground voltage VSS. The comparator 101 also generates the second comparison signal VCP2 having a level of 250 mV, which is lower than 0.5 V by 250 mV. The signal generator 201 may set the frequency of the first control signal FCON1 and the frequency of the second control signal FCON2 such that the frequency of the first control signal FCON1, generated in response to the first comparison signal VCP1 of 750 mV, is three times higher than the frequency of the second control signal FCON2 generated in response to the second comparison signal VCP2 of 250 mV.

For example, assuming that the power supply voltage VDD has a level of 1 V and the ground voltage VSS has a level of 0 V, the comparator 101 generates the first comparison signal VCP1 having a level of 0.2 V, which is lower by 300 mV than 0.5 V, which is ½ of the difference between the level of the power supply voltage VDD and the level of the ground voltage VSS. The comparator 101 generates the second comparison signal VCP2 having a level of 0.8 V, which is higher than 0.5 V by 300 mV. The signal generator 201 may set the frequency of the first control signal FCON1 and the frequency of the second control signal FCON2 such that the frequency of the second control signal FCON2, generated in response to the second comparison signal VCP2 of 0.8 V, is four times higher than the frequency of the first control signal FCON1 generated in response to the first comparison signal VCP1 of 0.2 V.

The frequency-to-digital converter 202 may change the digital value of the control code CCD<0:N> based on a frequency difference between the first control signal FCON1 and the second control signal FCON2.

In an embodiment, when the frequency of the first control signal FCON1 is greater than the frequency of the second control signal FCON2, the frequency-to-digital converter 202 generates the control code CCD<0:N> having a value that increases the magnitude of the coarse current ICO, which is transmitted to the control node CNND by the digital driver 203.

In an embodiment, when the frequency of the first control signal FCON1 is less than the frequency of the second control signal FCON2, the frequency-to-digital converter 202 generates a control code CCD<0:N> with a value that is used to determine a decrease in the magnitude of the coarse current ICO that is transmitted to the control node CNND by the digital driver 203.

In an embodiment, the frequency-to-digital converter 202 generates the control code CCD<0:N> having a disable value (minimum value) and does not change (increase or decrease) the magnitude of the coarse current ICO that is transmitted to the control node CNND by the digital driver 203.

More specifically, the control code CCD<0:N> may include an up code UCCD<0:N> and a down code DCCD<0:N>. That is, the frequency-to-digital converter 202 may change values of the up code UCCD<0:N> and the down code DCCD<0:N> based on a difference in frequency between the first control signal FCON1 and the second control signal FCON2.

Furthermore, when the frequency of the first control signal FCON1 is greater than the frequency of the second control signal FCON2, the frequency-to-digital converter 202 may change the value of the up code UCCD<0:N>. In a subsequent period after the value of the up code UCCD<0:N> is changed, the value of the down code DCCD<0:N> may be fixed to a disable value (a minimum value). When the frequency of the first control signal FCON1 is greater than the frequency of the second control signal FCON2, the frequency-to-digital converter 202 may increase the digital value of the up code UCCD<0:N> in proportion to a frequency difference between the first control signal FCON1 and the second control signal FCON2. When the frequency of the first control signal FCON1 is greater than the frequency of the second control signal FCON2, the frequency-to-digital converter 202 increases the value of the up code UCCD<0:N> to a greater extent as the frequency difference between the first control signal FCON1 and the second control signal FCON2 increases, but increases the value of the up code UCCD<0:N> to a lesser extent as the frequency difference between the first control signal FCON1 and the second control signal FCON2 decreases.

When the frequency of the second control signal FCON2 is lower than the frequency of the first control signal FCON1, the frequency-to-digital converter 202 may change the value of the down code DCCD<0:N>. In a subsequent period after the value of the down code DCCD<0:N> is changed, the value of the up code UCCD<0:N> may be fixed to a disable value (a minimum value). When the frequency of the second control signal FCON2 is greater than the frequency of the first control signal FCON1, the frequency-to-digital converter 202 may increase the digital value of the down code DCCD<0:N> in proportion to a frequency difference between the first control signal FCON1 and the second control signal FCON2. When the frequency of the second control signal FCON2 is less than the frequency of the first control signal FCON1, the frequency-to-digital converter 202 increases the value of the down code DCCD<0:N> to a greater extent as the frequency difference between the first control signal FCON1 and the second control signal FCON2 increases, but increases the value of the down code DCCD<0:N> to a lesser extent as the frequency difference between the first control signal FCON1 and the second control signal FCON2 decreases.

In addition, the digital driver 203 may adjust the magnitude of the coarse current ICO that is transmitted to the control node CNND, in a digital manner based on the digital value of the control code CCD<0:N>. That is, the digital driver 203 may increase or decrease the magnitude of the coarse current ICO that is transmitted to the control node CNND or disable the transmission of the coarse current ICO, according to the digital value of the control code CCD<0:N>.

More specifically, the digital driver 203 may adjust, in a digital manner, a magnitude of current sourced from the power supply voltage (VDD) terminal to the control node CNND according to the digital value of the up code UCCD<0:N> of the control code CCD<0:N>, thus increasing the magnitude of the coarse current ICO flowing to the control node CNND. That is, the digital driver 203 may increase the magnitude of the coarse current ICO to a greater extent as the digital value of the up code UCCD<0:N> increases. As such, when the digital driver 203 increases the magnitude of the coarse current ICO flowing to the control node CNND, the level of the control voltage VCON present at the control node CNND may increase.

Furthermore, the digital driver 203 may adjust, in a digital manner, the magnitude of current sunk from the control node CNND to the ground voltage terminal according to the digital value of the down code DCCD<0:N> of the control code CCD<0:N>, thus decreasing the magnitude of the coarse current ICO flowing to the control node CNND. That is, the digital driver 203 may decrease the magnitude of the coarse current ICO to a greater extent as the digital value of the down code DCCD<0:N> increases. As such, when the digital driver 203 decreases the magnitude of the coarse current ICO flowing to the control node CNND, the level of the control voltage VCON present at the control node CNND may decrease.

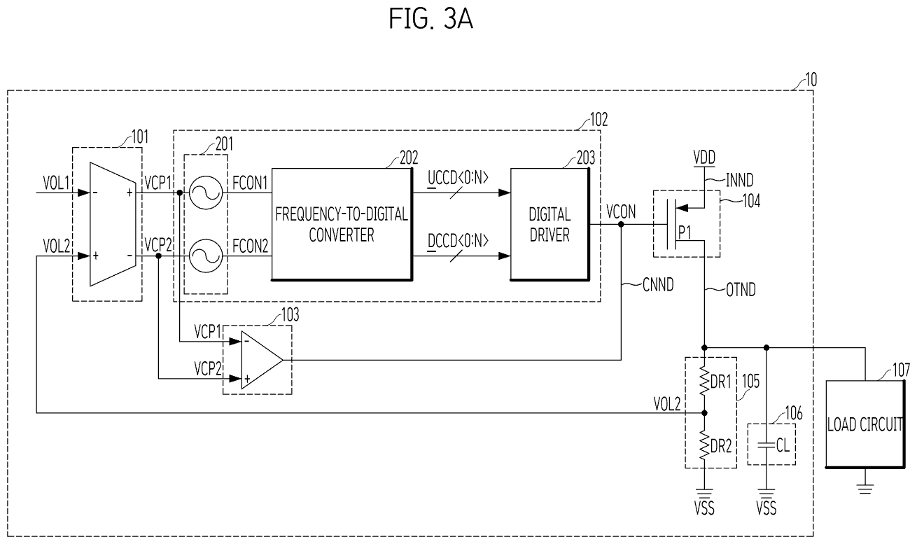

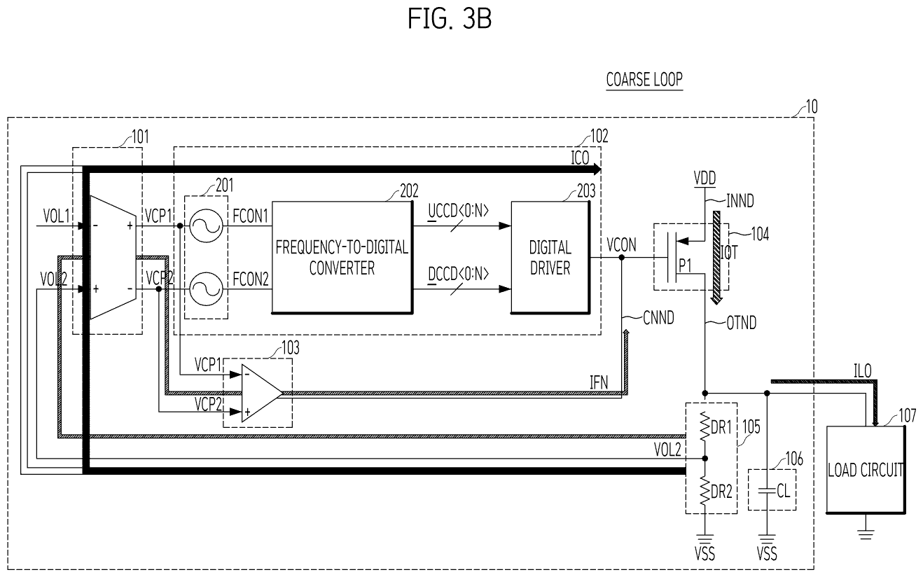

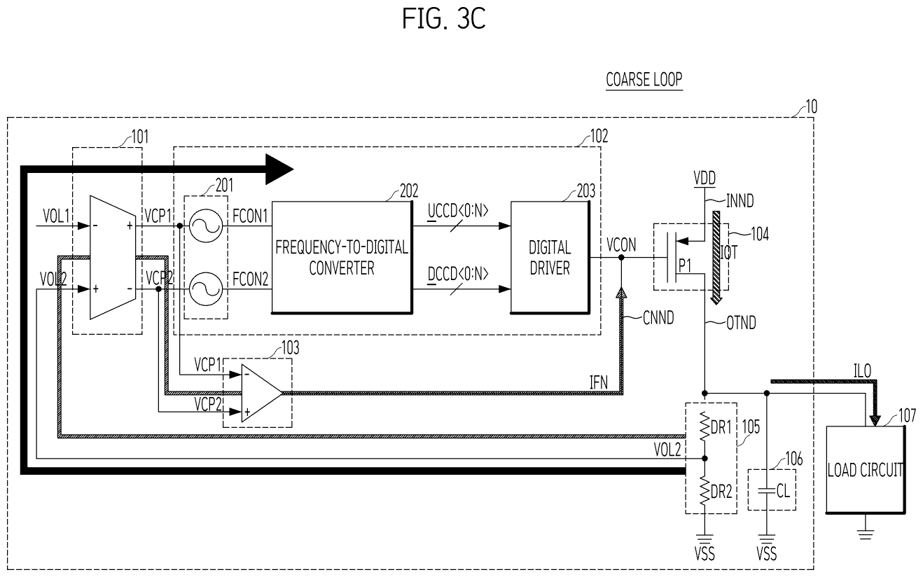

FIGS. 3A to 3C are diagrams illustrating a detailed circuit configuration and operation of a hybrid LDO regulator according to an embodiment of the disclosure.

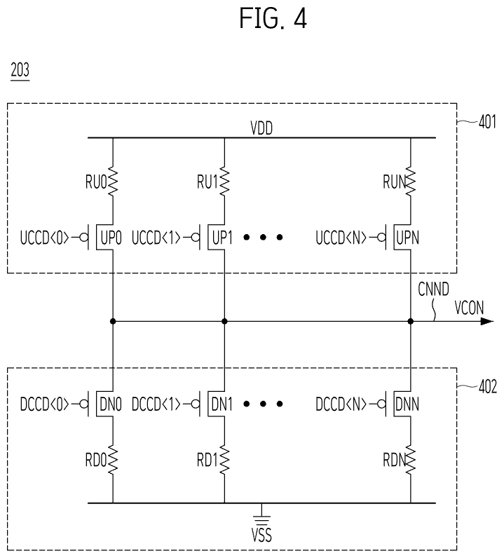

FIG. 4 is a diagram illustrating a detailed circuit configuration of a digital driver included in the coarse adjustment component among the components of a hybrid LDO regulator according to an embodiment of the disclosure.

Referring to FIG. 3A, as described above with reference to FIG. 1, a hybrid LDO regulator 10 may include a comparator 101, a coarse adjustment component 102, a fine adjustment component 103, an output component 104, a voltage divider 105, and a load capacitor 106. In addition, as described above with reference to FIG. 2, the coarse adjustment component 102 may include a signal generator 201, a frequency-to-digital converter 202, and a digital driver 203.

As such, the operations of the respective components included in the hybrid LDO regulator 10 are described above with reference to FIGS. 1 and 2, and thus are not described in detail herein. The following description is directed to an example circuit configuration that performs the operations of the respective components included in the hybrid LDO regulator 10.

First, the comparator 101 may be a fully differential amplifier. That is, the comparator 101 may determine a level difference between the first comparison signal VCP1 output through a positive (+) output terminal and the second comparison signal VCP2 output through a negative (−) output terminal, according to a level difference between the first voltage VOL1 input to a negative (−) input terminal and the second voltage VOL2 input to a positive (+) input terminal.

Accordingly, the level difference between the first comparison signal VCP1 and the second comparison signal VCP2 may be determined in an analog manner in proportion to the level difference between the first voltage VOL1 and the second voltage VOL2. In addition, the comparator 101 may determine the level difference between the first comparison signal VCP1 and the second comparison signal VCP2 in an analog manner by amplifying the level difference between the first voltage VOL1 and the second voltage VOL2 at a preset ratio. For example, the preset ratio indicates a gain value of the fully differential amplifier.

The signal generator 201 included in the coarse adjustment component 102 may include a first voltage-controlled oscillator (VCO) that receives the first comparison signal VCP1 and outputs the first control signal FCON1, and a second voltage-controlled oscillator that receives the second comparison signal VCP2 and outputs the second control signal FCON2.

Accordingly, the first voltage-controlled oscillator may determine the frequency of the first control signal FCON1 in an analog manner based on the level of the first comparison signal VCP1. That is, the first voltage-controlled oscillator may generate the first control signal FCON1, the frequency of which increases in response to an increase in the level of the first comparison signal VCP1.

Furthermore, the second voltage-controlled oscillator may determine the frequency of the second control signal FCON2 in an analog manner based on the level of the second comparison signal VCP2. That is, the second voltage-controlled oscillator may generate the second control signal FCON2, the frequency of which increases in response to an increase in the level of the second comparison signal VCP2.

A detailed circuit configuration of the frequency-to-digital converter 202 is highly complex and corresponds to known techniques, and thus is not described in detail herein. The detailed operation of the frequency-to-digital converter 202 can be understood with reference to FIG. 2 described above.

The digital driver 203 can be understood with reference to the circuit configuration illustrated in FIG. 4.

Referring to FIG. 3A to 4, the digital driver 203 may include an up driver 401 and a down driver 402.

The up driver 401 may adjust, in a digital manner, a magnitude of current sourced from the power supply voltage (VDD) terminal to the control node CNND according to the digital value of the up code UCCD<0:N> of the control code CCD<0:N>, thereby increasing the magnitude of the coarse current ICO flowing to the control node CNND. To this end, the up driver 401 may include a plurality of PMOS transistors UP<0:N> and a plurality of resistors RU<0:N> that control the amount of current sourced from the power supply voltage VDD terminal to the control node CNND according to values of respective bits included in the up code UCCD<0:N>. For example, the plurality of resistors RU<0:N> included in the up driver 401 are set to have the same value. In another example, the plurality of resistors RU<0:N> included in the up driver 401 are set to have different values.

The down driver 402 may adjust in a digital manner a magnitude of current sunk from the control node CNND to the ground voltage (VCC) terminal according to the digital value of the down code DCCD<0:N> of the control code CCD<0:N>, thereby decreasing the magnitude of the coarse current ICO flowing to the control node CNND. To this end, the down driver 402 may include a plurality of NMOS transistors DN<0:N> and a plurality of resistors RD<0:N> that control the amount of current sunk from the control node CNND to the ground voltage (VSS) terminal according to values of respective bits included in the down code DCCD<0:N>. For example, the plurality of resistors RD<0:N> included in the down driver 402 are set to have the same value. In another example, the plurality of resistors RD<0:N> included in the down driver 402 are set to have different values.

The fine adjustment component 103 may be a differential to single-ended amplifier. That is, the fine adjustment component 103 may adjust the magnitude of the fine current IFN transmitted to the control node CNND connected to the output terminal, according to a level difference between the first voltage VOL1 input to the negative (−) input terminal and the second voltage VOL2 input to the positive (+) input terminal.

The output component 104 may include a PMOS transistor P1 that adjusts the magnitude of the output current IOT flowing from the power supply voltage (VDD) terminal connected to a source terminal to the output node OTND connected to a drain terminal through the input node INND, in response to the level of the control voltage VCON present at that control node CNND that is applied to a gate terminal.

In an embodiment, as shown in the drawing, in the case where the output component 104 includes a single PMOS transistor P1, the coarse adjustment component 102 and the fine adjustment component 103 may control an operation of the output component 104 by sharing the control node CNND, thereby adjusting the magnitude of the output current IOT flowing from the control node CNND to the output node OTND.

In an embodiment, unlike the configuration shown in the drawing, it is also possible that the output component 104 includes first and second PMOS transistors connected in parallel between the input node INND and the output node OTND. In other words, the first PMOS transistor included in the output component 104 may have a gate terminal connected to a first control node, a source terminal connected to the input node INND, and a drain terminal connected to the output node OTND. In addition, the second PMOS transistor included in the output component 104 may have a gate terminal connected to a second control node, a source terminal connected to the input node INND, and a drain terminal connected to the output node OTND. In this case, the coarse adjustment component 102 may adjust a magnitude of current flowing from the input node INND to the output node OTND through the first PMOS transistor by adjusting the magnitude of the coarse current ICO transmitted to the first control node. In addition, the fine adjustment component 103 may adjust a magnitude of current flowing from the input node INND to the output node OTND through the second PMOS transistor by adjusting the magnitude of the fine current IFN transmitted to the second control node.

The voltage divider 105 may include resistors DR1 and DR2 configured to divide a level of the output voltage VOUT present at the output node OTND at a preset ratio.

A coarse loop operation of the hybrid LDO regulator 10 according to an embodiment, as described with reference to FIGS. 1 to 3A, may be understood with reference to FIG. 3B.

The coarse loop operation of the hybrid LDO regulator 10 according to an embodiment may be performed when a level difference between the first voltage VOL1 and the second voltage VOL2 exceeds a preset threshold value. In other words, the hybrid LDO regulator 10 in an enabled state may automatically perform the coarse loop operation when the level difference between the first voltage VOL1 and the second voltage VOL2 exceeds the preset threshold value.

Specifically, in the coarse loop operation, both the coarse adjustment component 102 and the fine adjustment component 103 may operate. That is, in a coarse loop operation period, the coarse adjustment component 102 may transmit the coarse current ICO to the control node CNND with a relatively greater current driving capability (e.g., ten times greater) than the fine adjustment component 103, thereby rapidly reducing a level difference between the first comparison signal VCP1 and the second comparison signal VCP2. Furthermore, the fine adjustment component 103 may transmit the fine current IFN to the control node CNND with a relatively smaller current driving capability (e.g., ten times smaller) than the coarse adjustment component 102 during the coarse loop operation period, thereby assisting in the operation of the coarse adjustment component 102 and reducing the level difference between the first comparison signal VCP1 and the second comparison signal VCP2.

A fine loop operation of the hybrid LDO regulator 10 according to an embodiment, as described with reference to FIGS. 1 to 3A, can be understood with reference to FIG. 3C.

The fine loop operation of the hybrid LDO regulator 10 according to an embodiment may be performed when a level difference between the first voltage VOL1 and the second voltage VOL2 is equal to or less than the preset threshold value. In other words, the hybrid LDO regulator 10 in an enabled state may automatically perform the fine loop operation when a level difference between the first voltage VOL1 and the second voltage VOL2 is equal to or less than the preset threshold value.

Specifically, in the fine loop operation, the coarse adjustment component 102 does not operate, and only the fine adjustment component 103 may operate. In other words, during the fine loop operation period, the coarse adjustment component 102 may not transmit the coarse current ICO to the control node CNND, because the coarse adjustment component 102 cannot detect a frequency difference between the first control signal FCON1 and the second control signal FCON2 during the fine loop operation period that would determine a need to a change the digital value of the control code CCD<0:N>. That is, the fine adjustment component 103 may transmit the fine current IFN to the control node CNND during the fine loop operation period, as in the coarse loop operation period.

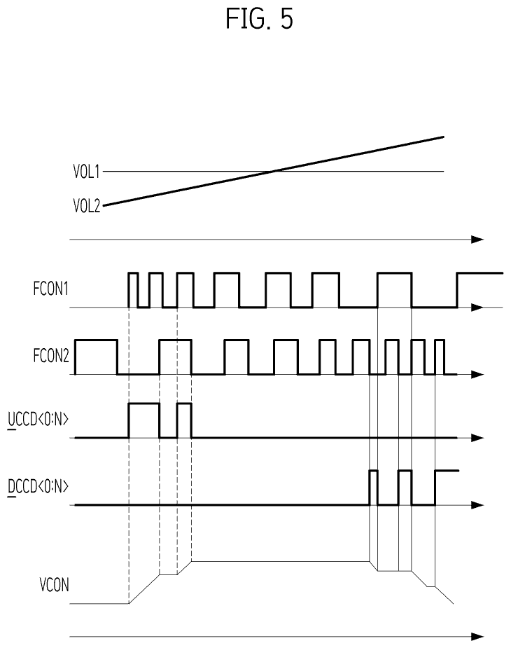

FIG. 5 is a diagram illustrating an operation of a coarse adjustment component according to a difference in voltage level between a first voltage and a second voltage in a hybrid LDO regulator according to an embodiment of the disclosure.

An operation of the coarse adjustment component 102 according to a level difference between the first voltage VOL1 and the second voltage VOL2 in the hybrid LDO regulator 10 is illustrated in FIG. 5.

Referring to the drawing, the first voltage VOL1 is fixed at a preset level.

The level of the second voltage VOL2 varies from a level lower than that of the first voltage VOL1 to a level higher than that of the first voltage VOL1. Note that the variation in the level of the second voltage VOL2 shown in the drawing is illustrative and merely for the purpose of explaining an operation of the coarse adjustment component 102 according to the level difference between the first voltage VOL1 and the second voltage VOL2, and might not actually occur during an actual regulating operation process.

In FIG. 5, when the second voltage VOL2 is less than the first voltage VOL1 by an amount greater than a threshold value, the signal generator 201 included in the coarse adjustment component 102 may generate the first control signal FCON1 and the second control signal FCON2 so that the first control signal FCON1 has a higher frequency than the second control signal FCON2.

Because the first control signal FCON1 has a higher frequency than the second control signal FCON2, the value of the up code UCCD<0:N> of the control code CCD<0:N> may increase, and the down code DCCD<0:N> may maintain a disable value.

In response to an increase in the value of the up code UCCD<0:N>, the level of the control voltage VCON applied to the control node CNND may increase.

Referring to FIG. 5, as second voltage VOL2 continues to increase, a level difference between the first voltage VOL1 and the second voltage VOL2 can become less than or equal to the threshold value when either the voltage is greater than the other. That is, when the second voltage VOL2 has a level that is either greater than or smaller than the first voltage VOL1 by an amount less than or equal to a threshold value, a frequency difference between the first control signal FCON1 and the second control signal FCON2 may be less than or equal to a threshold value.

When a frequency difference between the first control signal FCON1 and the second control signal FCON2 is less than or equal to the threshold value, the value of the control code CCD<0:N> may be maintained at a disable value. That is, both the up code UCCD<0:N> and the down code DCCD<0:N> included in the control code CCD<0:N> may be maintained at disable values.

Because both the up code UCCD<0:N> and the down code DCCD<0:N> are maintained at disable values, the level of the control voltage VCON present at the control node CNND may remain unchanged and maintain its current level.

Referring to FIG. 5, as second voltage VOL2 continues to increase, when the second voltage VOL2 has a level greater than the first voltage VOL1 by an amount greater than the threshold value, the signal generator 201 included in the coarse adjustment component 102 may generate the first control signal FCON1 and the second control signal FCON2 in such a way that the second control signal FCON2 has a higher frequency than the first control signal FCON1.

Because the second control signal FCON2 has a higher frequency than the first control signal FCON1, the value of the down code DCCD<0:N> of the control code CCD<0:N> may increase, and the up code UCCD<0:N> may be maintained at a disable value.

In response to an increase in the value of the down code DCCD<0:N>, the level of the control voltage VCON present at the control node CNND may decrease.

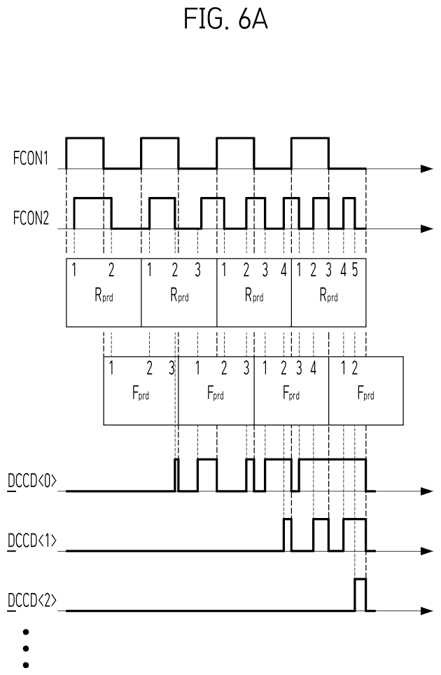

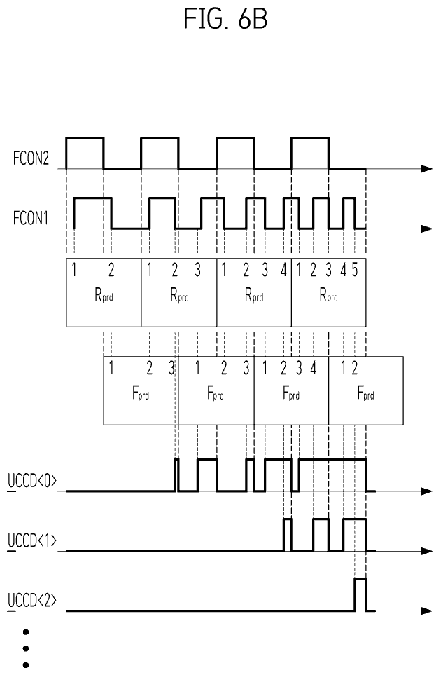

FIGS. 6A and 6B are diagrams illustrating operations of a frequency-to-digital converter in a hybrid LDO regulator according to an embodiment of the disclosure.

Operations of a frequency-to-digital converter 202 included in a coarse adjustment component 102 in a hybrid LDO regulator 10 can be understood with reference to FIGS. 6A and 6B, according to frequency differences between a first control signal FCON1 and a second control signal FCON2.

Referring to FIG. 6A, the frequency of the first control signal FCON1 is constant, and only the frequency of the second control signal FCON2 changes. Note that FIG. 6A is intended to illustrate an operation of the frequency-to-digital converter 202 according to a frequency difference between the first control signal FCON1 and the second control signal FCON2, and does not depict an operation actually performed during a regulating operation process.

Specifically, an interval between a rising edge and a subsequent rising edge of the first control signal FCON1 may be referred to as Rprd. In addition, an interval between a falling edge and a subsequent falling edge of the first control signal FCON1 may be referred to as Fprd.

The frequency-to-digital converter 202 may increase a value of the down code DCCD<0:N> of the control code CCD<0:N> in response to the occurrence of three or more rising or falling edges of the second control signal FCON2 in Rprd or Fprd.

For example, a 0th bit DCCD<0> of the down code DCCD<0:N> increases in value in response to a third edge (falling-rising-falling) of the second control signal FCON2 occurring in a first Fprd counted from the left, and is initialized at the end of the first Fprd counted from the left.

In another example, the 0th bit DCCD<0> of the down code DCCD<0:N> increases in value in response to a third edge (rising-falling-rising) of the second control signal FCON2 occurring in a second Rprd counted from the left, and is initialized at the end of the second Rprd counted from the left.

In another example, the 0th bit DCCD<0> of the down code DCCD<0:N> increases in value in response to a third edge (falling-rising-falling) of the second control signal FCON2 occurring in a third Rprd counted from the left, and is initialized at the end of the third Rprd counted from the left. In addition, a 1st bit DCCD<1> of the down code DCCD<0:N> may increase in value in response to a fourth edge (falling-rising-falling-rising) of the second control signal FCON2 occurring in the third Rprd counted from the left, and is initialized at the end of the third Rprd counted from the left.

In another example, the 0th bit DCCD<0> of the down code DCCD<0:N> increases in value in response to a third edge (falling-rising-falling) of the second control signal FCON2 occurring in a fourth Rprd counted from the left, and is initialized at the end of the fourth Rprd counted from the left. Furthermore, the 1st bit DCCD<1> of the down code DCCD<0:N> increases in value in response to a fourth edge (falling-rising-falling-rising) of the second control signal FCON2 occurring in the fourth Rprd counted from the left, and is initialized at the end of the fourth Rprd counted from the left. In addition, a 2nd bit DCCD<2> of the down code DCCD<0:N> increases in value in response to a fifth edge (falling-rising-falling-rising-falling) of the second control signal FCON2 occurring in a fourth Rprd counted from the left, and is initialized at the end of the fourth Rprd.

Referring to FIG. 6B, the frequency of the second control signal FCON2 is constant, and only the frequency of the first control signal FCON1 changes. Note that FIG. 6B is intended to illustrate an operation of the frequency-to-digital converter 202 in response to a frequency difference between the second control signal FCON2 and the first control signal FCON1, and does not depict an operation actually performed during a regulating operation process.

Specifically, an interval between a rising edge and a subsequent rising edge of the second control signal FCON2 may be referred to as Rprd. In addition, an interval between a falling edge and a subsequent falling edge of the second control signal FCON2 may be referred to as Fprd.

The frequency-to-digital converter 202 may increase a value of the up code UCCD<0:N> of the control code CCD<0:N> in response to the occurrence of three or more rising or falling edges of the first control signal FCON1 in Rprd or Fprd.

For example, a 0th bit UCCD<0> of the up code UCCD<0:N> increases in value in response to a third edge (falling-rising-falling) of the first control signal FCON1 occurring in a first Fprd counted from the left, and is initialized at the end of the first Fprd counted from the left.

In another example, the 0th bit UCCD<0> of the up code UCCD<0:N> increases in value in response to the third edge (rising-falling-rising) of the first control signal FCON1 occurring in a second Rprd counted from the left, and is initialized at the end of the second Rprd counted from the left.

In another example, the 0th bit UCCD<0> of the up code UCCD<0:N> increases in value in response to the third edge (falling-rising-falling) of the first control signal FCON1 occurring in a third Rprd counted from the left, and is initialized at the end of the third Rprd counted from the left. In addition, a 1st bit UCCD<1> of the up code UCCD<0:N> increases in value in response to a fourth edge (falling-rising-falling-rising) of the first control signal FCON1 occurring in the third Rprd counted from the left, and is initialized at the end of the third Rprd counted from the left.

In another example, the 0th bit UCCD<0> of the up code UCCD<0:N> increases in value in response to a third edge (falling-rising-falling) of the first control signal FCON1 occurring within a fourth Rprd counted from the left, and is initialized at the end of the fourth Rprd counted from the left. In addition, the 1st bit UCCD<1> of the up code UCCD<0:N> increases in value in response to a fourth edge (falling-rising-falling-rising) of the first control signal FCON1 occurring in the fourth Rprd counted from the left, and is initialized at the end of the fourth Rprd counted from the left. Furthermore, a 2nd bit UCCD<2> of the up code UCCD<0:N> increases in value in response to a fifth edge (falling-rising-falling-rising-falling) of the first control signal FCON1 occurring in the fourth Rprd counted from the left, and is initialized at the end of the fourth Rprd counted from the left.

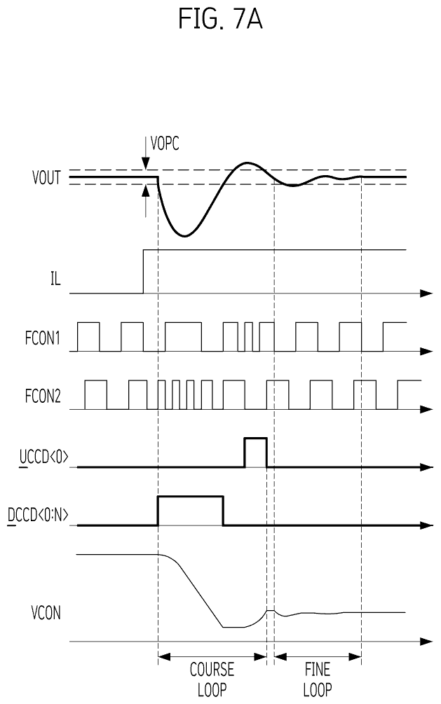

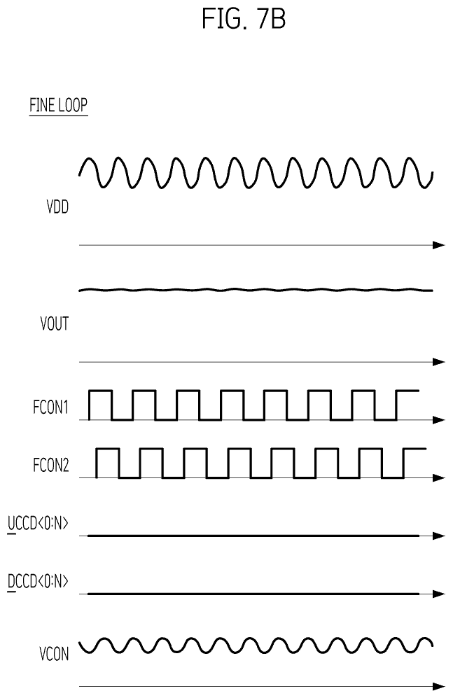

FIGS. 7A and 7B are diagrams illustrating an operation of a hybrid LDO regulator according to an embodiment of the disclosure.

An operation of the hybrid LDO regulator 10 according to an embodiment over time can be understood with reference to FIGS. 7A and 7B.

Referring to FIG. 7A, in an initial period where the output voltage VOUT present at the output node OTND is maintained at a target level, the frequencies of the first control signal FCON1 and the second control signal FCON2 are substantially equal (i.e., with a difference less than or equal to the threshold value). In this case, both the up code UCCD<0:N> and the down code DCCD<0:N> included in the control code CCD<0:N> may be maintained at disable values, and the level of the control voltage VCON present at a control node CNND may be maintained close to a level at which the output current IOT is not supplied to the output node OTND, for example, the level of the power supply voltage VDD.

Subsequently, in response to a rapid increase in consumption of the load current ILO while a preset operation is performed in a load circuit 107, the level of the output voltage VOUT present at the output node OTND may significantly decrease to a degree sufficient to initiate the operation of the coarse adjustment component 102, and in response thereto, the coarse loop operation may be initiated.

Specifically, when the level of the output voltage VOUT fluctuates within a threshold level range VOPC, the coarse adjustment component 102 may not detect a fluctuation of the level of the output voltage VOUT, and therefore, the coarse loop operation may not be initiated. However, because the drawing assumes that the level of the output voltage VOUT significantly decreases beyond the threshold level range VOPC, the coarse adjustment component 102 may detect a fluctuation in the level of the output voltage VOUT and, in response thereto, the coarse loop operation may be initiated.

For reference, initiation of the coarse loop operation may indicate not only that operation of the coarse adjustment component 102 has started, but also that operation of the fine adjustment component 103 has been initiated.

During the coarse loop operation period, in response to a significant decrease in the level of the output voltage VOUT present at the output node OTND, the frequency of the first control signal FCON1 may decrease, and the frequency of the second control signal FCON2 may increase. Accordingly, a frequency difference between the first control signal FCON1 and the second control signal FCON2 may exceed a threshold value. That is, the frequency difference may exceed the threshold value while the second control signal FCON2 has a higher frequency than the first control signal FCON1. Therefore, a value of the down code DCCD<0:N> of the control code CCD<0:N> may increase. In this case, the up code UCCD<0:N> of the control code CCD<0:N> may be maintained at a disable value.

In response to an increase in the value of the down code DCCD<0:N> of the control code CCD<0:N>, an operation of sinking a control current CONI (not illustrated) to the ground voltage (VSS) terminal may be performed at a control node CNND, and accordingly, the level of the control voltage VCON present at the control node CNND may decrease.

Because the level of the output voltage VOUT decreases to a significant extent due to an operation of the load circuit 107 at the beginning of the coarse loop operation period, the level of the control voltage VCON may also decrease to a significant extent in order to increase the output voltage VOUT. As the level of the control voltage VCON decreases to a significant extent, a substantial output current IOT may be supplied from the input node INND, which is connected to the power supply voltage (VDD) terminal, to the output node OTND. Accordingly, the level of the output voltage VOUT present at the output node OTND may increase.

Although the level of the output voltage VOUT significantly increases beyond the threshold level range VOPC, the operation of the coarse loop may not be terminated, and the coarse adjustment component 102 may continue operating.

During the coarse loop operation period, in response to a significant increase in the level of the output voltage VOUT present at an output node OTND, the frequency of the first control signal FCON1 may increase, and the frequency of the second control signal FCON2 may decrease. Accordingly, a frequency difference between the first control signal FCON1 and the second control signal FCON2 may exceed the threshold value. That is, the frequency difference may exceed the threshold value while the frequency of the first control signal FCON1 is higher than that of the second control signal FCON2. As a result, a value of the up code UCCD<0:N> of the control code CCD<0:N> may increase, and the down code DCCD<0:N> of the control code CCD<0:N> may be maintained at a disable value.

In response to the increase in the value of the up code UCCD<0:N> of a control code CCD<0:N>, an operation of sourcing the control current CONI from the power supply voltage (VDD) terminal to the control node CNND may be performed, and accordingly, the level of the control voltage VCON present at the control node CNND may increase. In response to the increase in the level of the control voltage VCON, the magnitude of the output current IOT supplied from the input node INND, which is connected to the power supply voltage (VDD) terminal, to the output node OTND may decrease. Therefore, the level of the output voltage VOUT present at the output node OTND may decrease to within the threshold level range VOPC.

In response to the level of the output voltage VOUT decreasing within the threshold level range VOPC, the coarse adjustment component 102 cannot detect a fluctuation in the level of the output voltage VOUT, and therefore, the coarse adjustment component 102 may no longer operate. Accordingly, the hybrid LDO regulator 10 may enter the fine loop, and only the fine adjustment component 103 may perform an operation. In other words, during the coarse loop operation period, both the coarse adjustment component 102 and the fine adjustment component 103 may operate, and then, in response to a condition in which the operation of the coarse adjustment component 102 ends and only the fine adjustment component 103 operates, the fine loop operation may be initiated or continue to operate.

During the fine loop operation period, the fine adjustment component 103 may operate in an analog manner and may rapidly increase and decrease the level of the output voltage VOUT within the threshold level range VOPC. Accordingly, at a time point when the fine loop operation period ends, the output voltage VOUT may be stably maintained at the target level.

Referring to FIG. 7B, it can be seen that, during the fine loop operation period, the fine adjustment component 103 offsets noise input through the power supply voltage (VDD) terminal.

Specifically, even while the output voltage VOUT is maintained at the target level during the fine loop operation period, the level of the power supply voltage VDD supplied from an external device may continuously fluctuate in an irregular manner due to the influence of noise.

During the fine loop operation period, the fine adjustment component 103 may compensate for the level of the power supply voltage VDD, which irregularly fluctuates, in an analog manner. In other words, even if the level of the output voltage present at the output node OTND slightly fluctuates due to an irregular variation in the level of the power supply voltage VDD during the fine loop operation period, the fine adjustment component 103 may detect the slight fluctuation in the level of the output voltage in an analog manner and finely vary the value of the control current CONI transmitted to the control node CNND. Accordingly, the fine adjustment component 103 may vary the level of the control voltage VCON present at the control node CNND with a variation smaller than a variation in the level of the power supply voltage VDD, and may vary the level of the output voltage VOUT present at the output node OTND with a variation smaller than a variation of the level of the control voltage VCON. As such, during the fine loop operation period, the fine adjustment component 103 may prevent noise input through the power supply voltage (VDD) terminal from being transmitted to the output node OTND.

Even if the level of the power supply voltage VDD supplied from the external device irregularly fluctuates during the fine loop operation period, the level of the output voltage VOUT does not fluctuate beyond the threshold level range VOPC, and therefore, the coarse adjustment component 102 may not detect the fluctuation in the level of the output voltage VOUT.

Accordingly, as shown in the drawings, when the fine adjustment component 103 performs an operation of offsetting noise input through the power supply voltage VDD terminal during the fine loop operation period, the signal generator 201 included in the coarse adjustment component 102 may generate the first control signal FCON1 and the second control signal FCON2 in a state where a frequency difference therebetween is less than or equal to the threshold value, that is, in a state where the two signals have almost the same frequency. Therefore, both the up code UCCD<0:N> and the down code DCCD<0:N> included in the control code CCD<0:N> may be maintained in a state having a disable value. As a result, during the fine loop operation period, the coarse adjustment component 102 may not perform any operation.

An LDO regulator according to various embodiments may operate in a hybrid manner that automatically switches between a digital manner and an analog manner depending on an extent by which a level of an output voltage differs from a target level. The hybrid LDO regulator according to various embodiments may operate in a digital manner during an initial operation in which a difference between the level of the output voltage and the target level is relatively large, and may operate in an analog manner during a later operation in which the difference is relatively small.

Accordingly, a voltage regulating operation that is resistant to supply noise and has high accuracy may be achieved with minimized current consumption.

It will be evident to a person having ordinary knowledge in the art to which the present disclosure pertains that the present disclosure described above is not limited by the aforementioned embodiments and the accompanying drawings and that the present disclosure may be substituted, modified, and changed in various ways without departing from the technical spirit of the present disclosure.

For example, the positions and kinds of the logic gates and transistors described in the above embodiments may be different according to the polarity of an input signal.

What is claimed is:

1. A low drop-out (LDO) regulator comprising:
a comparator configured to generate a first comparison signal and a second comparison signal between which a level difference is determined in an analog manner, based on a level difference between a first voltage having a preset level and a second voltage provided from an output node;
a coarse adjustment component configured to determine a frequency of a first control signal and a frequency of a second control signal based on a level of the first comparison signal and a level of the second comparison signal, respectively, and to adjust a magnitude of a coarse current that is transmitted to a control node, in a digital manner based on a frequency difference between the first control signal and the second control signal;
a fine adjustment component configured to adjust a magnitude of a fine current that is transmitted to the control node, in an analog manner based on the level difference between the first comparison signal and the second comparison signal; and
an output component configured to adjust a magnitude of an output current that is transmitted from an input node to the output node, according to a level of a control voltage present at the control node, and to adjust a level of an output voltage present at the output node.

2. The LDO regulator of claim 1, wherein the coarse adjustment component is configured to change a digital value of a control code based on the frequency difference between the first control signal and the second control signal, and to adjust the magnitude of the coarse current in a digital manner according to the digital value of the control code.

3. The LDO regulator of claim 2, wherein the coarse adjustment component comprises:
a signal generator configured to determine, in an analog manner, the frequency of the first control signal and the frequency of the second control signal based on the level of the first comparison signal and the level of second comparison signal, respectively;
a frequency-to-digital converter configured to change the digital value of the control code based on the frequency difference between the first control signal and the second control signal; and
a digital driver configured to adjust the magnitude of the coarse current in a digital manner according to the digital value of the control code, and to supply the coarse current to the control node.

4. The LDO regulator of claim 3, wherein the signal generator determines a magnitude of the frequency of the first control signal and a magnitude of the frequency of the second control signal in proportion to the level of the first comparison signal and the level of the second comparison signal, respectively.

5. The LDO regulator of claim 4, wherein the frequency-to-digital converter is configured
to change a digital value of an up code of the control code when the frequency of the first control signal is higher than the frequency of the second control signal, and
to change a digital value of a down code of the control code when the frequency of the second control signal is higher than the frequency of the first control signal.

6. The LDO regulator of claim 5, wherein the digital driver comprises:
an up driver configured to increase the magnitude of the coarse current by adjusting, in a digital manner, a magnitude of a current sourced from a power supply voltage terminal to the control node according to the digital value of the up code; and
a down driver configured to decrease the magnitude of the coarse current by adjusting, in a digital manner, a magnitude of a current sunk from the control node to a ground voltage terminal according to the digital value of the down code.

7. The LDO regulator of claim 1, wherein the fine adjustment component is configured
to increase the magnitude of the fine current by adjusting, in an analog manner, the magnitude of a current sourced from a power supply voltage terminal to the control node, when the level of the second comparison signal is higher than the level of the first comparison signal, and
to decrease the magnitude of the fine current by adjusting, in an analog manner, the magnitude of a current sunk from the control node to a ground voltage terminal, when the level of the second comparison signal is lower than the level of the first comparison signal.

8. The LDO regulator of claim 1, further comprising a voltage divider configured to output the second voltage by dividing the level of the output voltage at a preset ratio.

9. The LDO regulator of claim 1, wherein the comparator amplifies the level difference between the first voltage and the second voltage at a preset ratio, and determines, in an analog manner, the level difference between the first comparison signal and the second comparison signal.

10. A semiconductor device comprising:
a low drop-out (LDO) regulator configured to: generate a first comparison signal and a second comparison signal between which a level difference is determined in an analog manner based on a level difference between a first voltage having a preset level and a second voltage provided from an output node; convert the level difference between the first comparison signal and the second comparison signal to a frequency difference and adjust, in a digital manner, a magnitude of a coarse current that is transmitted to a control node; adjust a magnitude of a fine current that is transmitted to the control node, in an analog manner according to the level difference between the first comparison signal and the second comparison signal; and adjust a magnitude of an output current that is transmitted from an input node to the output node, based on the magnitude of the coarse current and the magnitude of the fine current; and
a load circuit configured to receive at least a portion of the output current transmitted through the output node, as a load current, and to perform a preset operation.

11. The semiconductor device of claim 10, wherein the LDO regulator comprises:
a comparator configured to generate the first comparison signal and the second comparison signal between which the level difference is determined in an analog manner according to the level difference between the first voltage and the second voltage;
a coarse adjustment component configured to determine a frequency of a first control signal and a frequency of a second control signal based on a level of the first comparison signal and a level of the second comparison signal, respectively, and to adjust the magnitude of the coarse current in a digital manner based on a frequency difference between the first control signal and the second control signal;
a fine adjustment component configured to adjust the magnitude of the fine current in an analog manner based on the level difference between the first comparison signal and the second comparison signal; and
an output component configured to adjust the magnitude of the output current according to a level of a control voltage present at the control node, and to adjust a level of an output voltage present at the output node.

12. The semiconductor device of claim 11, wherein the coarse adjustment component changes a digital value of a control code based on the frequency difference between the first control signal and the second control signal, and adjusts the magnitude of the coarse current in a digital manner according to the digital value of the control code.

13. The semiconductor device of claim 12, wherein the coarse adjustment component comprises:
a signal generator configured to determine, in an analog manner, the frequency of the first control signal and the frequency of the second control signal based on the level of the first comparison signal and the level of second comparison signal, respectively;
a frequency-to-digital converter configured to change the digital value of the control code based on the frequency difference between the first control signal and the second control signal; and
a digital driver configured to adjust the magnitude of the coarse current in a digital manner according to the digital value of the control code and supply the coarse current to the control node.

14. The semiconductor device of claim 13, wherein the signal generator determines a magnitude of the frequency of the first control signal and a magnitude of the frequency of the second control signal in proportion to the level of the first comparison signal and the level of the second comparison signal, respectively.

15. The semiconductor device of claim 14, wherein the frequency-to-digital converter is configured
to change a digital value of an up code of the control code when the frequency of the first control signal is higher than the frequency of the second control signal, and
to change a digital value of a down code of the control code when the frequency of the second control signal is higher than the frequency of the first control signal.

16. The semiconductor device of claim 15, wherein the digital driver comprises:
an up driver configured to increase the magnitude of the coarse current by adjusting, in a digital manner, a magnitude of a current sourced from a power supply voltage terminal to the control node according to the digital value of the up code; and
a down driver configured to decrease the magnitude of the coarse current by adjusting, in a digital manner, a magnitude of a current sunk from the control node to a ground voltage terminal according to the digital value of the down code.

17. The semiconductor device of claim 11, wherein the fine adjustment component is configured
to increase the magnitude of the fine current by adjusting, in an analog manner, a magnitude of a current sourced from a power supply voltage terminal to the control node, when the level of the second comparison signal is higher than the level of the first comparison signal, and
to decrease the magnitude of the fine current by adjusting, in an analog manner, a magnitude of a current sunk from the control node to a ground voltage terminal, when the level of the second comparison signal is lower than the level of the first comparison signal.

18. The semiconductor device of claim 11, wherein the LDO regulator further comprises a voltage divider configured to output the second voltage by dividing the level of the output voltage at a preset ratio.

19. The semiconductor device of claim 11, wherein the comparator amplifies the level difference between the first voltage and the second voltage at a preset ratio, and determines, in an analog manner, the level difference between the first comparison signal and the second comparison signal.
